(19) United States
(12) Patent Application Publication
(10) Pub. No.: US 2003/0006586 A1
(43) Pub. Date: Jan. 9, 2003

(54) Heavy duty, knockdown industrial cart

(76) Inventor: John P. Comilla, Novi, MN (US)

Correspondence Address: HARNESS, DICKEY & PIERCE, P.L.C., P.O. BOX 828, BLOOMFIELD HILLS, MI, 48303, US

(21) Appl. No.: 09/899,411

(22) Filed: Jul. 5, 2001

(51) Int. Cl. B62B 1/20

(52) U.S. Cl. 280/651; 280/47.34

(57) ABSTRACT

A heavy duty, knock-down industrial cart for holding and transporting relatively heavy objects is formed of a generally rectangular base frame having rigid, interconnected elongated side and end strips upon which wood boards are rested to form a support floor. The boards span between opposing side strips and the ends of the boards are clamped upon the side strips by metal angle strips each having a horizontal leg overlying the board ends and a vertical leg fastened to their respective side strips. Vertical posts are secured to the base frame strips and support wheels are secured to the bottom of the frame. The frame strips, posts and boards are fastened together by releasable mechanical fasteners so that the parts forming the cart may be manually assembled and disassembled and one or more damaged boards can be removed and replaced with new boards when discarded.

### FIELD OF THE INVENTION

This invention relates to an improved hand cart of the type used, for example, within factories to carry manufactured parts from one location to another and usually moved manually, such as by pushing or pulling, for short distances.

### BACKGROUND OF THE INVENTION

Conventional hand carts that are used in factories and warehouses, generally comprise a platform or base which is supported upon wheels and provided with suitable railings or posts for assisting in containing articles placed upon the surface of the base. Typically, the platforms or bases of such carts are made of metal sheet material or of wood to form floors or surfaces upon which the articles to be transported are positioned. Because such carts are normally used casually, that is, without particular care, they frequently are damaged. Particularly, the article carrying surfaces of the carts tend to become dented or broken or stained with oils or other liquids that are used in manufacturing processes and which accumulate upon manufactured parts. Thus, conventional carts have relatively limited lives, particularly where they are used to carry heavy, oil or other liquid coated parts within manufacturing plants. Repair of these carts take time. Consequently, damaged or worn carts frequently are discarded or are not used to full capacity because of lack of necessary repairs.

For many uses it is desirable to use carts whose load supporting surfaces are made of wood. But wood flooring or surfaces can be damaged easily or can absorb oil. Repairing or replacing wood surfaces can take time and some skilled labor.

In addition, the initial delivery of new or rebuilt carts to a plant or warehouse, as well as subsequent storage or transport to places other than initial locations, is relatively difficult because carts are bulky and ordinarily cannot be stacked, one upon another for transport on a truck. Thus, it would be desirable to have a cart which can be easily transported and easily stored notwithstanding its bulk when actually used.

The present invention contemplates providing a heavy duty cart which is capable of handling relatively rough, large and heavy industrial parts and which can be easily pushed or pulled short distances manually or with a tractor or tug and at the same time, despite its relatively large bulk, can be quickly and easily manually disassembled for transportation or storage purposes. Further, the invention herein contemplates forming the cart with a wood support surface which can be partially replaced, as needed, with only unskilled manual effort using simple hand tools.

### SUMMARY OF THE INVENTION

This invention contemplates forming an industrial type, heavy duty, cart made of a horizontal, metal strip frame that is covered with a wood floor. The floor is connected to the frame by clamping strips that frictionally hold the wood floor upon the frame. The strips can be easily and quickly fastened to or removed from the frame in order to replace or repair the wood floor. Preferably, the wood floor is made of a series of elongated wood boards that are arranged side by side with their ends frictionally clamped to the metal frame. The frame is supported upon wheels for rollingly moving the cart. Suitable posts, with railings and braces are connected to the frame. Preferably, the parts are all connected together by manually engagable and removable fasteners, such as by bolts and nuts, so that the entire cart, including the wood plank or board flooring can be quickly disassembled and assembled. The disassembled unit may be stored or shipped as a knock-down item and quickly re-assembled into its large, relatively bulky state, for use in transporting items.

An object of this invention is to provide an inexpensive, yet sturdy cart capable of supporting relatively heavy industrial parts, as for example heavy engine parts or the like, within a factory, or heavy containers within a warehouse, but which cart can be assembled and disassembled when desired.

Moreover, another object of this invention is to provide an industrial transport cart having a wood support surface, which reduces damage to articles carried thereon, but which can be easily either entirely or partially removed and replaced, as necessary when damaged or when stained, with oil or other liquids.

Yet a further object of this invention is to provide a relatively attractive device which can be easily and quickly assembled and can be partially disassembled and repaired, as needed, by unskilled labor using common hand tools, such as a pair of pliers or a wrench.

It is desired to provide a hand cart which can support relatively heavy weights, can be easily moved, and yet is inexpensive to make and easy to repair, by replacing worn or broken parts, when necessary.

These and other objects and advantages of this invention will become apparent upon reading the following description of which the attached drawings form a part. It should be understood that the detailed description and specific examples indicate a preferred embodiment of the invention and are intended for purposes of illustration only and are not intended to limit the scope of the invention.

### DESCRIPTION OF THE DRAWINGS

FIG. 1 is a perspective drawing illustrating an assembled cart of this invention.

FIG. 2 is a front elevational view of the cart.

FIG. 3 is a bottom view, looking upwardly towards the bottom of the cart.

FIG. 4 is a perspective, disassembled view showing the major parts of the cart.

FIG. 5 is an enlarged, perspective view, showing a corner of the cart frame with the parts disassembled.

FIG. 6 is a perspective fragmentary view showing the corner assembly of the frame and end posts.

FIG. 7 is an enlarged, fragmentary perspective view, showing the fastening of the wood flooring to the frame of the cart.

FIG. 8 illustrates a perspective view of a modified form of cart wherein a different post or rail arrangement is used, and

FIG. 9 is a perspective view of a second modification illustrating another arrangement for attaching the posts upon the cart.

FIG. 10 is a side elevational view of the cart with yet another arrangement of the posts or railings.

FIG. 11 is an enlarged, perspective view of a socket for receiving the lower end of a side post.

FIG. 12 is an enlarged, perspective view illustrating the use of tube-like channels to form the strips that are used to form the frame.

FIG. 13 is a fragmentary, elevational view of a lower portion of the cart, illustrating the support wheels.

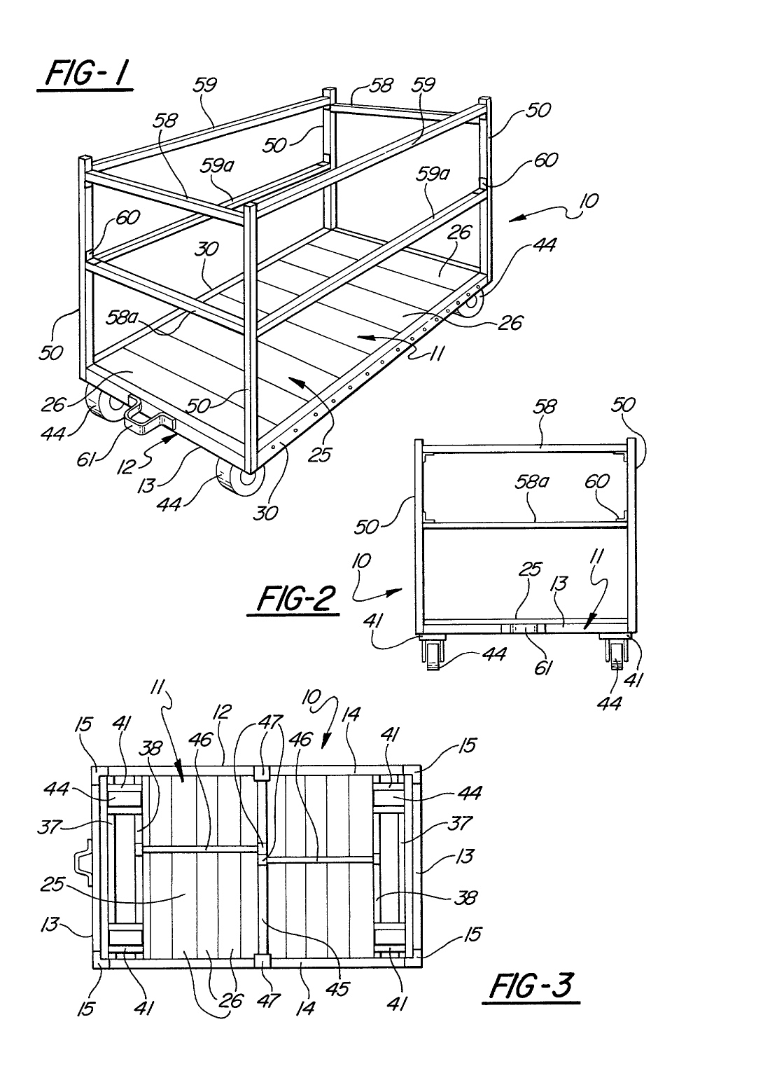

### DETAILED DESCRIPTION OF THE PREFERRED EMBODIMENTS

The following description of the preferred embodiment(s) exemplifies a preferred mode and is not intended to limit the claimed invention, its application, or uses.

FIG. 1 illustrates in perspective, a cart 10 having a base or platform 11. The size of the cart may vary considerably depending upon its intended use. An example would be on the order of about five feet long and about three feet wide for a typical use within an industrial factory or warehouse. The base is formed of a horizontal frame 12 which is made of tubular or channel elongated strips. The strips form a rectangular arrangement with opposite end strips 13 and opposite side strips 14 connected together at their adjacent ends.

The ends of the strips may be connected together by suitable connectors. An example of a suitable connector 15 is illustrated in FIGS. 5 and 6. This connector is formed of a metal plate which is slit and bent to form integral vertical flanges 18 and integral horizontally bent flanges 19. Holes 20 are drilled or punched in the horizontal flanges 19. These holes are aligned with holes 21 formed in the end portions of the strips so that mechanical fasteners, such as bolts 22 (see FIG. 6) can be inserted through the holes 20 and the holes 21 for connecting the adjacent ends of the strips 13 and 14 and forming a corner of the frame. Similar corners are formed in the frame for connecting all four of the strips.

A wood floor 25 is formed of boards or planks 26 that span the space between the opposite side strips of the frame. The end portions of the boards are rested upon the upper surfaces of the ends of the side strips 14. In order to fit the first and last of the boards upon the frame, corner notches 27 may be cut in them which permits them to snuggly fit around the vertical flanges 18 of the corner connectors 15. (See FIG. 1).

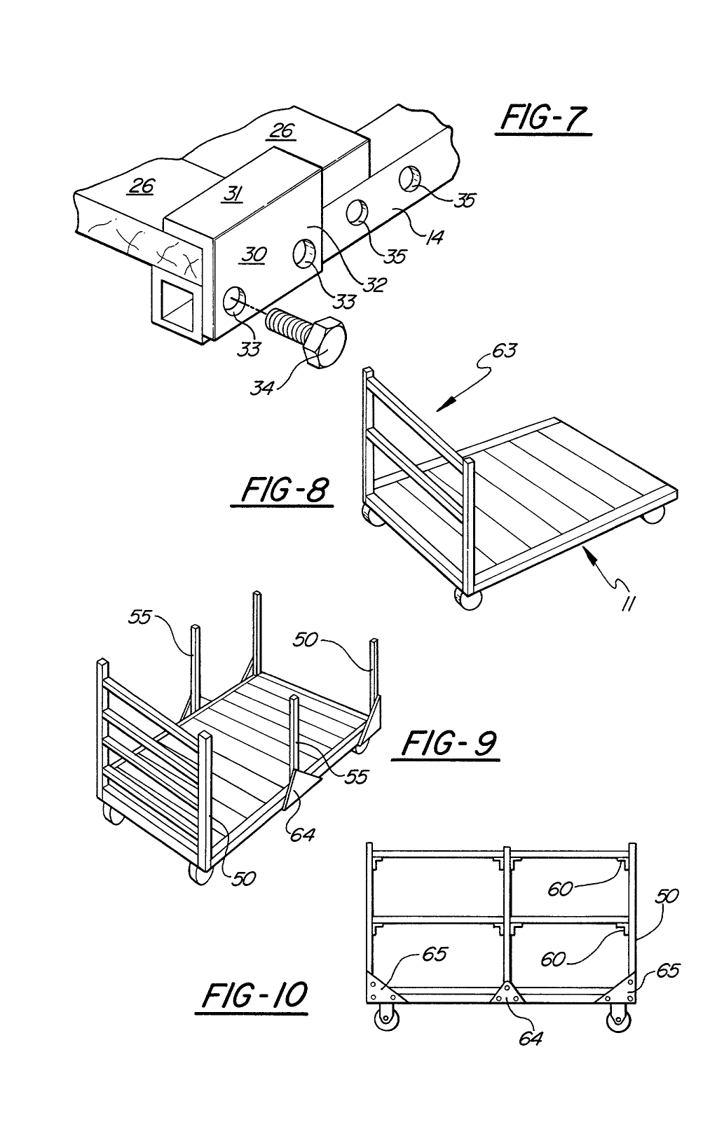

In order to fasten the boards, which are arranged side by side, preferably in contact with each other, upon the frame, fastener members 30 are provided. (see FIG. 7) These fastener members are in the form of right angle-incross-section elongated strips, each having a horizontal leg 31 and an integral vertical leg 32 having holes 33 spaced along its leg. After the end portions of the boards are positioned upon the upper surfaces of the opposing side strips 18, bolts 34 are inserted through the holes 33 in the vertical legs of the fastening members. The bolts extend through aligned holes 35 that are formed along the length of the side strips. Those holes may be round or may be oblong or elongated so that precise dimensions are not required in order to permit assembly of the parts to each other.

The fastener members 30 preferably clamp the end portions of the boards upon the side strips of the frame and hold the boards in place by friction. Although some pinning might be used, preferably, the friction grasp or clamping of the fastening members against the wood boards is sufficient to hold the boards tightly in place and even permit some slight movement of the boards relative to the frame to absorb impacts, such as a loose, heavy part dropped upon them.

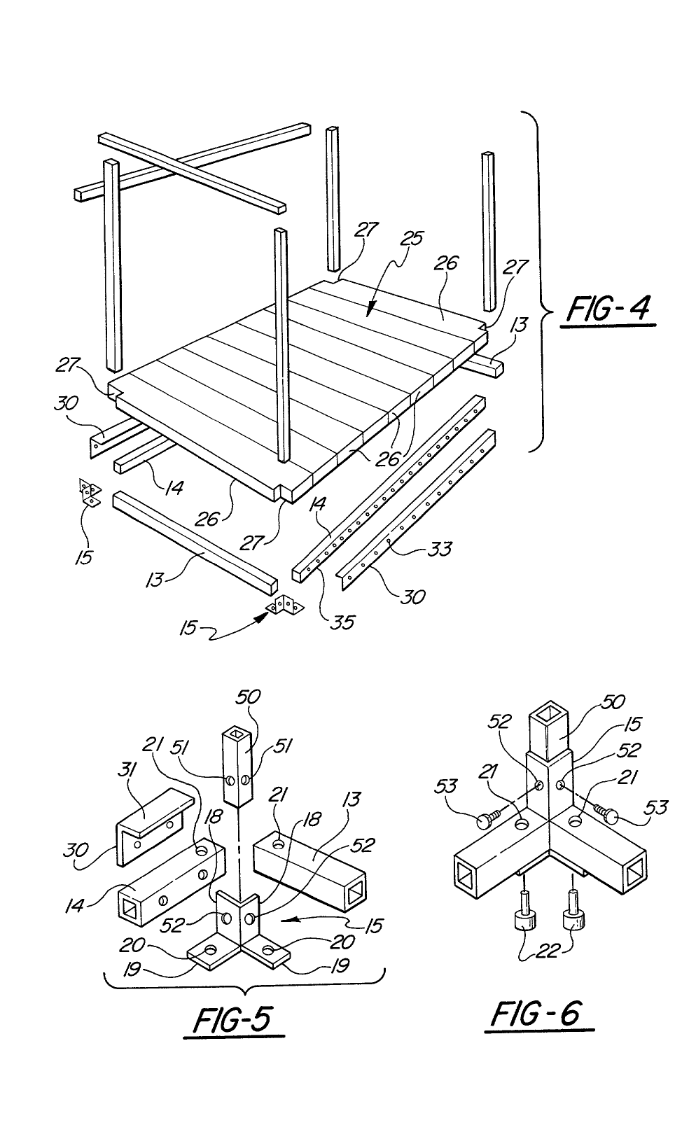

The frame 12 carries wheels or rollers so as to enable the users to easily push or pull the cart along a floor, such as a building floor or upon the ground. The wheel assembly (see FIG. 13) includes a pair of cross strips 37 and 38 (see FIG. 3) which are secured by connector brackets 39 and bolts to the side strips 14 of the frame. The wheel assembly 40 includes a flat, horizontal plate 41 arranged beneath the pair of cross strips 37 and 39 and secured thereto by suitable bolts 42. The plate carries a horizontally rotatable inverted U-shaped yoke 43 which, in turn, carries the rotatable wheel or roller 44. The wheel assembly is a conventional assembly and therefore no further description is included here.

In order to rigidify the frame, a center brace strip 45 (see FIG. 3) has it opposite ends secured by a suitable bracket and bolts (not shown) to the opposite frame side strips 14. Longitudinally directed brace strips 46 are connected to the center brace strip 45 and a cross strip 38 by means of a suitable connector plate 47. Such connector plates may be used to also connect the center brace strip to the side strips.

The assembled base or platform 11 may be provided with support rails and vertical posts. These posts may be assembled upon the frame in various configurations such as are illustrated in FIGS. 1, 8, 9 and 10. The posts 50 at the corners of the frame are provided with holes 51 (see FIG. 5) at their lower ends which, in turn, are aligned with holes 52 formed in the vertical flanges 18 of the corner connectors 15. Bolts 53 inserted through the aligned holes secure the posts in upright position. (see FIG. 6) As shown in FIG. 9, center posts 55 may also be assembled upon the frame. The center posts may be secured to the frame by a conventional connector, such as a socket member 56 (see FIG. 11) which is secured by bolts 57 to the side strips 14 of the frame. Suitable horizontal end rails or braces 58 and 58a may be connected to the end posts 50 at either or both opposite ends of the cart. FIG. 1 illustrates the lower brace 58a secured to only one pair of end posts. Similarly, longitudinally extending side braces or rails 59 and 59a may extend between the opposite end posts. These braces or rails may be connected by angle brackets 60 and bolts (not shown).

In addition, an eye or loop piece 61 may be bolted to one or both of the frame end strips 13 to enable the cart to be attached, by a suitable hook, to a tractor or other powered moving mechanism or to another cart.

The arrangements of the posts and rails or braces may be varied depending upon the particular needs at a specific location. For example, the modification FIG. 8 shows the posts and rails arranged only at one end of the platform 11 to provide a handle-like structure 63 where the platform may be manually grasped for moving the cart. FIG. 9 illustrates another modification of a post arrangement where center posts 55 are fastened to the frame strips by means of triangular shaped plates 64 and bolts (not shown) (see FIG. 9). In addition, a number of braces may be used to connect the end posts.

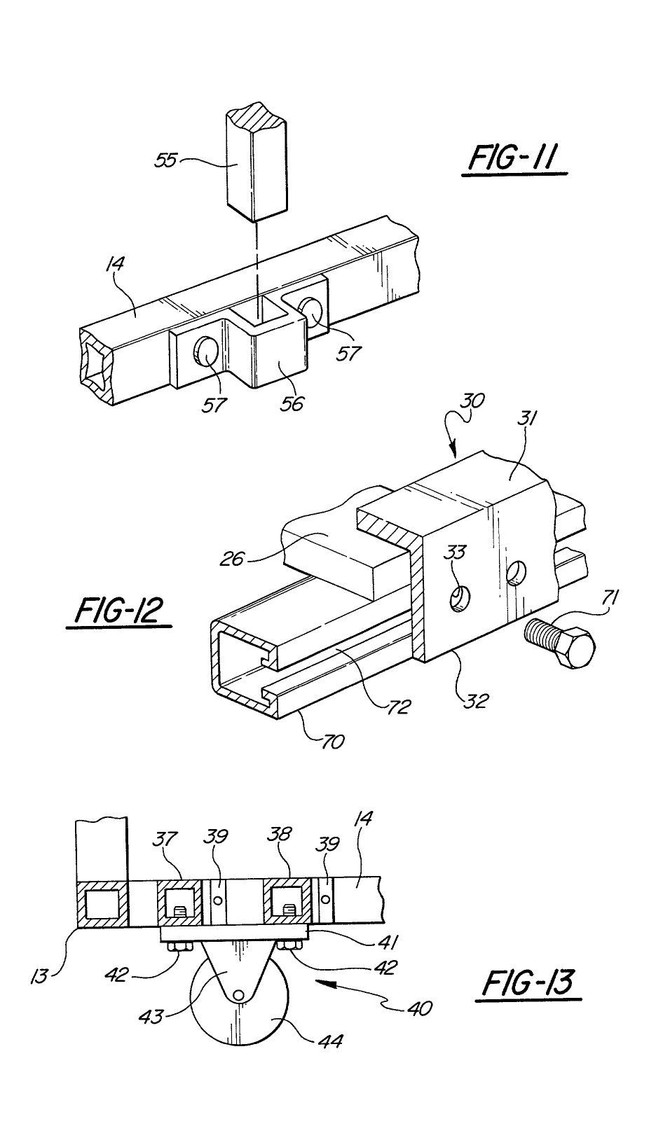

FIG. 10 illustrates another modified arrangement of the posts and longitudinal rails or braces along the sides of the platform to form a retaining wall for holding large parts or containers. Triangular shaped brackets 65, bolted to the adjacent ends of the posts and to the frame strips, are used to connect the end posts with the frame instead of using the corner connectors 15.

The side and end strips may be made of extruded or roll formed tubing, preferably square cross-section or rectangular cross section tubing. However, as an alternative, roll formed or extruded channels 70 may be used to form the frame strips and the posts. FIG. 12 shows the use of conventional channels 70 such are commonly used in forming heavy duty shelving. The channels are cut to the lengths required for the end and side strips. Then, angled connector fasteners 30 may be fastened to the channels by inserting bolts 71 through the channel slots or openings 72 for engaging conventional nuts or nut-like members located within the channels (not shown). These, being conventional articles, are easy to use and commercially available for this purpose.

As can be seen, the various parts that make up the posts and braces can be assembled in different configurations for different purposes. No matter how assembled, however they are easily disassembled and reassembled when desired using simple hand tools, such as a wrench or a pair of pliers or a screw driver. The assembly and disassembly can be quickly performed manually. Thus, a damaged cart, such as having a floor board damaged or cracked or stained with oil or with other fluids, can be quickly removed and replaced by loosening the bolts holding the fastener members 30 to the side strips 14 enough to enable the removal of the particular damaged board or boards and replacing them with clean, fresh boards. Thus, the cart can be easily kept in good repair and ready for use as needed. Moreover, the cart may be easily transported or stored by disassembling the parts and moving them, in knock-down condition, for reassembly when needed.

Having fully described at least one preferred embodiment of this invention, it is desired that the foregoing description be read as illustrative. This invention may be further developed within the scope of the following claims.

What is claimed is:

1. A heavy duty, industrial cart for holding and transporting relatively heavy articles comprising;
a generally rectangular, horizontally arranged frame formed of elongated, narrow side and end strips connected together at their adjacent ends to define a space within the frame;
a wood floor overlying the frame space and having opposite edges rested upon opposite side strip and end strips;
releasable connector members releasably fastening the floor edges to their respective frame strips;
support wheels arranged beneath and secured to the frame for supporting the frame upon a support surface and for enabling the cart to be moved by pushing or pulling it upon the support surface;
vertically extending poles having lower ends connected to said frame;
and the frame strips and the poles being connected together by manually releasable fasteners whereby the cart may be disassembled for storage or transportation and may be manually reassembled for use when desired.

2. A heavy duty, industrial cart as defined in claim 1 and said wood floor comprising a series of elongated wood boards closely arranged side by side to form a wood upper surface for supporting articles carried by the cart;
and with the opposite ends of each of the boards rested upon and supported upon the opposite side strips of the frame so that the boards each extend across the space between the frame side strips;
an elongated, angular-in-cross section fastener member having a vertical leg arranged along one frame side strip and having a horizontal leg overlapping the board end portions rested upon that side strip, with the horizontal leg clamping the board end portions to the respective side strips;
and releasable mechanical fasteners securing said vertical leg to said side strip;
whereby some or all of the boards may be manually removed when desired, such as when damaged or worn or stained, and may be manually replaced with similar boards by temporarily releasing said fastener member for release of the boards to be removed.

3. A heavy duty, industrial cart as defined in claim 2 and said posts being arranged at one end of the frame and secured to the frame corners formed by the connected ends of the side and end strips;
at least one generally horizontal brace member extending between and interconnecting the posts.

4. A heavy duty industrial cart as defined in claim 3, and said posts being secured to the frame by manually removable mechanical fasteners, and said brace member having opposite ends connected to the respective posts by manually releasable fasteners whereby the posts and brace member may be assembled and disassembled from the other parts of the cart as desired.

5. A heavy duty industrial cart as defined in claim 2, and including rotatable support wheels secured to, and beneath, the frame for rollingly supporting the frame for movement thereof.

6. A heavy duty industrial cart as defined in claim 2, and including said mechanical fasteners for securing the frame side and end strips together being in the form of integral horizontally arranged plates extending at rights angles to each other and having an integral upright plate for connecting the upright plate to a post and for connecting the horizontal plates to an end strip and a side strip respectively.

7. A heavy duty industrial cart as defined in claim 2, and the strips forming said frame being made of elongated tubes with at least the tubes forming the side strips being provided with spaced apart openings along their lengths for receiving bolts for fastening the angular fastener members thereto.

8. A heavy duty industrial cart as defined in claim 2 and said frame side strips being formed of elongated metal channels, and mechanical fasteners extending through openings formed in said fastener member and into said metal channels for securing the fastener members and channels to each other.

9. A heavy duty industrial cart as defined in claim 2, and with the end portions of the boards each being frictionally held against its respective frame side strip by the fastener member.

10. A construction as defined in claim 9, and with the opposite end portions of the boards each being clamped and frictionally held against its respective frame side strip by similar angle-in-cross-section fastener members having a horizontal flange with overlaps the adjacent board end portions and clamps the boards to their respective side strips.

11. A heavy duty industrial cart as defined in claim 1, and said wood floor comprising a panel having its edges arranged to overlap adjacent frame strips;
and with the opposite edges of the panel which overlap the opposite side strips of the frame being secured thereon by elongated, angular-in-cross section fastener members, each having a vertical leg arranged along one frame side strip and a horizontal leg overlapping the edge portions of the panel rested upon that side strip and clamping the panel to its respective side strip;
and with releasable mechanical fasteners securing the vertical legs of to said side strips;
whereby the panel may be manually removed and replaced when desired by temporarily removing and replacing at least one of the fastener members.

12. A heavy duty industrial cart as defined in claim 11, and including said horizontal legs frictionally holding the edge portions of the wood panel upon their respective frame side strips and being otherwise physically unconnected to said wood edges.

13. A heavy duty industrial cart for supporting and transporting relatively heavy articles comprising:
a horizontally arranged, generally rectangular frame formed of elongated, narrow, side and end strips connected together at their adjacent ends;
a wood floor overlying the space between opposite side strips, with said wood floor being formed of a number of narrow boards, arranged side by side to provide a substantially continuous load supporting surface;
the boards having their opposite edge portions overlapping the side strips of the frame and being clamped upon the respective side strips by elongated angular shaped in-cross-section fastener members having vertically arranged legs fastened by removable mechanical fasteners to their respective side strips and horizontally arranged legs overlapping the edge portions of the boards and clamping and holding the board edge portions against their respective side members;
support wheels arranged beneath and secured to the frame for rollingly supporting the frame upon a surface;
vertically extending poles having lower ends connected to said frames;
and the frame strips and the poles and the fastener members being connected together by manually releasable and appliable fasteners whereby the cart may be disassembled and reassembled manually when desired and one or more boards may be removed and replaced when desired.
